(19) United States
(12) Patent Application Publication
(10) Pub. No.: US 2025/0046802 A1
(43) Pub. Date: Feb. 6, 2025

(54) BATTERY

(71) Applicant: Panasonic Intellectual Property Management Co., Ltd., Osaka (JP)

(72) Inventors: SHUJI ITO, Nara (JP); TADAAKI MATSUMURA, Shiga (JP)

(21) Appl. No.: 18/924,334

(22) Filed: Oct. 23, 2024

Related U.S. Application Data
(63) Continuation of application No. PCT/JP2022/044224, filed on Nov. 30, 2022.

(30) Foreign Application Priority Data
May 16, 2022 (JP) 2022-080112

(51) Int. Cl. H01M 4/38; H01M 4/02; H01M 10/0562

(52) U.S. Cl. CPC H01M 4/386; H01M 4/382; H01M 10/0562; H01M 2004/027

(57) ABSTRACT

The battery of the present disclosure includes: a positive electrode; a negative electrode; and a solid electrolyte layer located between the positive electrode and the negative electrode. The positive electrode contains, as a positive electrode active material, a metal oxide containing lithium, and the negative electrode includes a negative electrode current collector and a negative electrode active material layer located between the negative electrode current collector and the solid electrolyte layer. The negative electrode active material layer contains, as a negative electrode active material, silicon with lithium pre-stored therein. The atomic ratio of lithium to silicon in the negative electrode active material layer in a fully charged state is less than or equal to 3.5.

### BACKGROUND

### 1. Technical Field

The present disclosure relates to a battery.

### 2. Description of the Related Art

Japanese Unexamined Patent Application Publication No. 2018-073513 discloses an all-solid lithium ion battery including a negative electrode active material layer containing silicon oxide in a surface layer.

Japanese Unexamined Patent Application Publication No. 2018-133131 discloses an all-solid lithium ion secondary battery including a negative electrode containing a Si—Li alloy having closed pores containing He gas.

### SUMMARY

One non-limiting and exemplary embodiment provides a battery having improved discharge rate characteristics.

In one general aspect, the techniques disclosed here feature a battery including: a positive electrode; a negative electrode; and a solid electrolyte layer located between the positive electrode and the negative electrode, wherein the positive electrode contains, as a positive electrode active material, a metal oxide containing lithium, wherein the negative electrode includes a negative electrode current collector and a negative electrode active material layer located between the negative electrode current collector and the solid electrolyte layer, wherein the negative electrode active material layer contains, as a negative electrode active material, silicon with lithium pre-stored therein, and wherein the atomic ratio of lithium to silicon in the negative electrode active material layer in a fully charged state is less than or equal to 3.5.

The present disclosure provides a battery with improved discharge rate characteristics.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view showing a schematic structure of a battery in an embodiment;

FIG. 2 is a 1C discharge curve of a battery 1 in an Example;

FIG. 3A is a graph showing the relation between the 1C discharge capacity retention rate and the atomic ratio Li/Si and the relation between the average discharge voltage and the atomic ratio Li/Si for batteries 1 and 1-1 in Examples;

FIG. 3B is a graph showing the relation between the 1C discharge capacity retention rate and the atomic ratio Li/Si and the relation between the average discharge voltage and the atomic ratio Li/Si for batteries 2, 2-1, and 2-2 in Examples; and

FIG. 3C is a graph showing the relation between the 1C discharge capacity retention rate and the atomic ratio Li/Si and the relation between the average discharge voltage and the atomic ratio Li/Si for batteries 3, 3-1, 3-2, and 3-3 in Examples.

### DETAILED DESCRIPTIONS

### Underlying Knowledge Forming Basis of the Present Disclosure

To address the rapid spread of electric vehicles, there is an urgent need to develop vehicle-mounted lithium secondary batteries having features such as high safety, high performance, and long life. Moreover, to improve the convenience of electric vehicles, there is a need to increase the cruising distance per charge and shorten the charging time. To allow lithium secondary batteries to have high energy density or high capacity, the development of high-capacity negative electrode materials is important. For example, silicon is a promising high-capacity negative electrode material. However, a silicon negative electrode having both high capacity and good discharge rate characteristics has not been obtained.

Japanese Unexamined Patent Application Publication No. 2018-073513 discloses an all-solid lithium ion battery including a negative electrode active material layer containing silicon oxide in a surface layer. Japanese Unexamined Patent Application Publication No. 2018-133131 discloses an all-solid lithium ion secondary battery including a negative electrode containing a Si—Li alloy having closed pores containing He gas.

In the battery in Japanese Unexamined Patent Application Publication No. 2018-073513 and the battery in Japanese Unexamined Patent Application Publication No. 2018-133131, lithium is stored in silicon serving as a negative electrode active material during a charging process, and a lithium-silicon alloy is thereby formed. Since silicon is a semimetal, the electron conductivity of silicon is intrinsically poor. However, silicon with lithium stored therein is a mixed conductor exhibiting electron conductivity and also having ion conductivity and functions as a negative electrode active material. Therefore, in a battery in a low SOC (State Of Charge: charging rate) with a low lithium storage amount and in a battery including a negative electrode with a large basis weight, it is feared that the discharge rate characteristics may deteriorate.

In recent years, research and development of all-solid batteries using a solid electrolyte as an electrolyte has been actively conduced. A production method of an all-solid battery differs from a production method of a liquid battery using an electrolyte solution as an electrolyte. In a production process of an all-solid battery, it is necessary to apply pressure to the battery by constraining the battery in order to prevent the internal structure of the battery from being damaged during charging and discharging. The constraining pressure has a large influence on the characteristics of the all-solid battery. The volume change rate of silicon during charging and discharging is large. Therefore, if the constraining pressure during the production of a battery using silicon as a negative electrode active material is low, the discharge rate characteristics of the battery are particularly likely to deteriorate. To avoid this problem, when silicon is used as the negative electrode active material, a solid electrolyte, conductive carbon, etc. are generally added to the negative electrode.

The present inventors have conducted extensive studies on batteries including a negative electrode containing silicon as a negative electrode active material in order to improve the discharge rate characteristics. Thus, the inventors have arrived at the battery of the disclosure.

Summary of aspects of present disclosure

A battery according to a first aspect of the present disclosure includes:
a positive electrode;
a negative electrode; and
a solid electrolyte layer located between the positive electrode and the negative electrode,
wherein the positive electrode contains, as a positive electrode active material, a metal oxide containing lithium,
wherein the negative electrode includes a negative electrode current collector and a negative electrode active material layer located between the negative electrode current collector and the solid electrolyte layer,
wherein the negative electrode active material layer contains, as a negative electrode active material, silicon with lithium pre-stored therein, and wherein the atomic ratio of lithium to silicon in the negative electrode active material layer in a fully charged state is less than or equal to 3.5.

In the first aspect, since lithium has already been stored in silicon used as the negative electrode active material at the time of assembly of the battery or before the initial charging, the silicon has higher electron conductivity than silicon with no lithium stored therein. Therefore, the discharge rate characteristics of the battery can be improved.

According to a second aspect of the present disclosure, for example, in the battery according to the first aspect, the ratio of the charge capacity per unit area of the negative electrode to the charge capacity per unit area of the positive electrode may be more than or equal to 1.9. In the battery configured as described above, good discharge rate characteristics can be achieved more reliably.

According to a third aspect of the present disclosure, for example, in the battery according to the first aspect, the atomic ratio of lithium to silicon in the negative electrode active material layer in a fully discharged state may be more than or equal to 0.5. In the battery configured as described above, good discharge rate characteristics can be achieved more reliably.

According to a fourth aspect of the present disclosure, for example, in the battery according to the first aspect, the negative electrode active material layer may contain no electrolyte. In the battery configured as described above, the discharge rate characteristics of the battery are improved.

According to a fifth aspect of the present disclosure, for example, in the battery according to the first aspect, the solid electrolyte layer may contain a solid electrolyte having lithium ion conductivity. In the battery configured as described above, the discharge rate characteristics of the battery are improved.

According to a sixth aspect of the present disclosure, for example, in the battery according to the fifth aspect, the solid electrolyte may contain a sulfide solid electrolyte. In the battery configured as described above, the discharge rate characteristics of the battery are improved.

A method of using a battery according to a seventh aspect of the present disclosure includes charging the battery including a positive electrode containing, as a positive electrode active material, a metal oxide containing lithium and a negative electrode including a negative electrode active material layer containing, as a negative electrode active material, silicon with lithium pre-stored therein, the battery being charged such that the atomic ratio of lithium to silicon in the negative electrode active material layer in a fully charged state is less than or equal to 3.5.

In the seventh aspect, since lithium has already been stored in the silicon used as the negative electrode active material in a fully discharged state such as at the time of assembly of the battery or before the initial charging, the silicon has higher electron conductivity than silicon with no lithium stored therein. Therefore, the discharge rate characteristics of the battery can be improved.

Embodiments of the present disclosure will be described with reference to the drawings. However, the present disclosure is not limited to the following embodiments.

### EMBODIMENTS

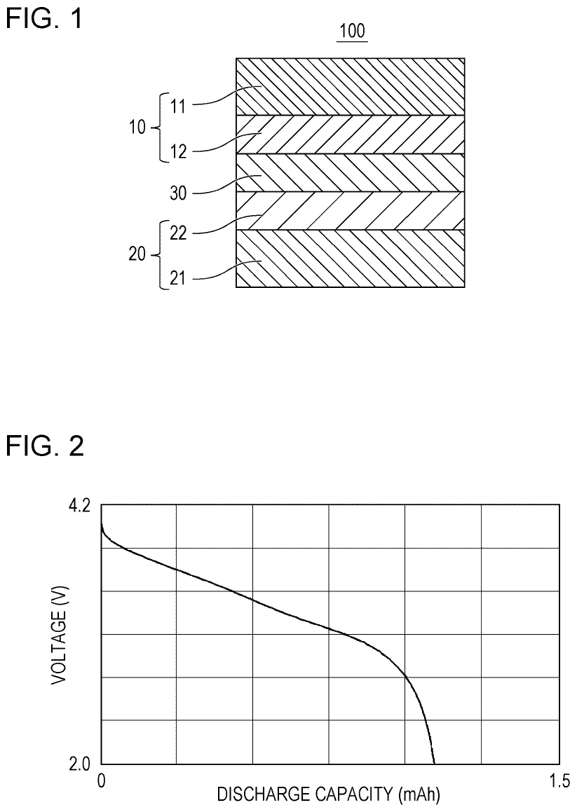

FIG. 1 is a cross-sectional view showing a schematic structure of a battery 100 in an embodiment. The battery 100 includes a positive electrode 10, a negative electrode 20, and a solid electrolyte layer 30 located between the positive electrode 10 and the negative electrode 20. The negative electrode 20 includes a negative electrode current collector 21 and a negative electrode active material layer 22 located between the negative electrode current collector 21 and the solid electrolyte layer 30. The positive electrode 10 contains, as a positive electrode active material, a metal oxide containing lithium. The negative electrode active material layer 22 contains, as a negative electrode active material, silicon with lithium pre-stored therein.

In a battery using silicon as a negative electrode active material (for example, Japanese Unexamined Patent Application Publication No. 2018-073513 and Japanese Unexamined Patent Application Publication No. 2018-133131), lithium is generally stored in silicon at the initial charging after the assembly of the battery, and a lithium-silicon alloy is thereby formed. In this manner, the silicon function as the negative electrode active material. In the battery 100 in the present embodiment, since the silicon with lithium pre-stored therein is used as the negative electrode active material, the silicon has high electron conductivity even in a fully discharged state such as at the assembly of the battery or before the initial charging. Therefore, the discharge rate characteristics of the battery 100 can be improved.

The silicon with lithium pre-stored therein can be produced using a negative electrode active material layer containing silicon particles. Examples of the method that can be used include a method in which a metal lithium foil is press-bonded to the surface of the negative electrode active material layer, a method in which a vacuum evaporation method, for example, is used to deposit metallic lithium on the surface of the negative electrode active material layer, a method in which an electrochemical method with metallic lithium etc. used as a counter electrode is used to store lithium in the negative electrode active material layer, and a method in which the negative electrode active material layer is immersed in a lithium-naphthalenide solution to chemically store lithium in the negative electrode active material layer. Lithium can also be pre-stored in silicon by mixing silicon particles and metallic lithium particles using, for example, a ball mill or immersing silicon particles in a lithium-naphthalenide solution to produce lithium-containing silicon particles and then producing the negative electrode active material layer.

The ratio N/P of the charge capacity N per unit area of the negative electrode 20 to the charge capacity P per unit area of the positive electrode 10 may be more than or equal to 1.9 and may be more than or equal to 2.0. In this case, the utilization rate and volume change rate of the silicon serving as the negative electrode active material can be reduced, and it is expected to improve the cycle characteristics. When silicon with lithium pre-stored to its storage limit is used as the negative electrode active material to form a battery, lithium not stored in the silicon will precipitate in a dendritic form during a charging process. The lithium precipitated in a dendritic form may pierce the solid electrolyte layer, causing a short circuit between the negative electrode and the positive electrode. However, when the ratio N/P is more than or equal to 1.9, the negative electrode active material layer still has room for storage of lithium even in a fully charged state, and the occurrence of dendritic precipitation of lithium not stored in the silicon during a charging process can be avoided. Specifically, a short circuit between the negative electrode 20 and the positive electrode 10 is avoided. When silicon is used as the negative electrode active material, it is feared that, since the thickness of the negative electrode active material increases, a reduction in discharge rate characteristics may occur due to a reduction in electron conductivity. However, in the battery 100 in the present embodiment, since the silicon with lithium pre-stored therein is used as the negative electrode active material, a reduction in the discharge rate characteristics can be prevented, and good discharge rate characteristics can be achieved more reliably. No particular limitation is imposed on the upper limit of the ratio N/P. The upper limit is, for example, 3.0.

In the present disclosure, the “fully charged state” is a state in which the battery is charged at a constant current (e.g., 0.05C with respect to the theoretical capacity) to a prescribed voltage (e.g., a negative electrode potential of 0 V with respect to the potential of a lithium reference electrode). The “fully discharged state” is a state in which the battery is discharged at a constant current (e.g., 0.05C with respect to the theoretical capacity) to a prescribed voltage (e.g., a negative electrode potential of 2.0 V with respect to the potential of the lithium reference electrode).

The ratio N/P is determined by dividing the charge capacity N (mAh/cm²) per unit area of the negative electrode 20 by the charge capacity P (mAh/cm²) per unit area of the positive electrode 10.

The charge capacity N per unit area of the negative electrode 20 can be determined, for example, by the following method. First, a half-cell including a silicon-made negative electrode serving as a working electrode and a counter electrode using metallic lithium or indium lithium is produced. Next, the half-cell is charged at a current rate of 0.05C to 0 V with respect to the potential of the metallic lithium to measure the initial charge capacity (mAh). A value obtained by converting the initial charge capacity to a capacity per unit mass of silicon is defined as A_{N}(mAh/g). The mass of silicon serving as the negative electrode active material contained in a unit area of the negative electrode 20 is defined as B_{N}(mg/cm²). The product of A_{N}(mAh/g) and B_{N}(mg/cm²) is used to compute the charge capacity N per unit area of the negative electrode 20 (mAh/cm²).

When the positive electrode active material has an average discharge potential of around 3.7 V vs Li/Li⁺ with respect to the oxidation-reduction potential of metallic lithium, the charge capacity P per unit area of the positive electrode 10 can be determined, for example, by the following method. The above positive electrode active material is, for example, a lithium-containing transition metal oxide such as Li(Ni,Co,Al) O₂, Li(Ni,Co,Mn) O₂, LiCoO₂, or LiMn₂O₄. First, a half-cell including a positive electrode formed of the positive electrode active material and serving as a working electrode and a counter electrode using metallic lithium or indium lithium is produced. Next, the half-cell is charged at a current rate of 0.05C to 4.3 V with respect to the potential of the metallic lithium to measure the initial charge capacity (mAh). A value obtained by converting the initial charge capacity to a capacity per unit mass of the positive electrode active material is defined as A_{P}(mAh/g). The mass of the positive electrode active material contained in a unit area of the positive electrode 10 is defined as B_{P}(mg/cm²). The product of A_{P} (mAh/g) and B_{P}(mg/cm²) is used to compute the charge capacity P (mAh/cm²) per unit area of the positive electrode 10. When the positive electrode active material has an average discharge potential of around 3.4 V vs Li/Li⁺ with respect to the oxidation-reduction potential of metallic lithium, the charge capacity P can be determined, for example, by the following method. The above positive electrode active material is, for example, LiFePO₄. First, a half-cell including a positive electrode formed of the positive electrode active material and serving as a working electrode and a counter electrode using metallic lithium or indium lithium is produced. Next, the half-cell is charged at a current rate of 0.05C to 3.9 V with respect to the potential of the metallic lithium to measure the initial charge capacity (mAh). A value obtained by converting the initial charge capacity to a capacity per unit mass of the positive electrode active material is defined as A_{P} (mAh/g). The mass of the positive electrode active material contained in a unit area of the positive electrode 10 is defined as B_{P}(mg/cm²). The product of A_{P}(mAh/g) and Bp (mg/cm²) is used to compute the charge capacity P (mAh/cm²) per unit area of the positive electrode 10.

In the present disclosure, the notation “(A,B,C)” in a chemical formula means “at least one selected from the group consisting of A, B, and C.” For example, “(Ni,Co,Al)” is synonymous with “at least one selected from the group consisting of Ni, Co, and Al.” The same applies to other elements.

In the present disclosure, the charge capacity P per unit area of the positive electrode 10 and the charge capacity N per unit area of the negative electrode 20 are intended to mean not only the charge capacity per unit area of the positive electrode 10 and the charge capacity per unit area of the negative electrode 20 in a state in which the battery 100 has not yet been charged after the assembly but also the charge capacity per unit area of the positive electrode 10 and the charge capacity per unit area of the negative electrode 20 in a state in which the battery 100 has been charged and discharged for at least one cycle for, for example, a product test before sale in the market.

The atomic ratio Li/Si of lithium to silicon in the negative electrode active material layer 22 in the fully charged state may be less than or equal to 4 and may be less than or equal to 3.5. When the atomic ratio Li/Si in the negative electrode active material layer 22 in the fully charged state is less than or equal to 4, the occurrence of dendritic precipitation of lithium during a charging process can be avoided. Therefore, good discharge rate characteristics can be achieved more reliably. No particular limitation is imposed on the lower limit of the atomic ratio Li/Si in the negative electrode active material layer 22 in the fully charged state. The lower limit is, for example, 2.0.

The atomic ratio Li/Si in the negative electrode active material layer 22 in the fully charged state can be computed, for example, by the following method. First, before the assembly of the battery 100, the negative electrode active material layer 22 is used to determine a capacity X (mAh/g) when a unit mass of silicon is energized. Next, the battery 100 is assembled and charged at a constant current corresponding to 20 hour rate (0.05C rate) to 4.2 V. Then the battery 100 is discharged at a current value corresponding to 0.05C rate to 2.0 V. A value obtained by converting the charge capacity (mAh) of the battery 100 at the first cycle to the charge capacity (mAh) per unit mass of silicon is defined as Y (mAh/g). The sum of X (mAh/g) and Y (mAh/g) is divided by 954 mAh/g, and the atomic ratio Li/Si in the negative electrode active material layer 22 in the fully charged state can thereby be computed. The above 954 mAh/g is a value obtained by converting the capacity necessary to allow a silicon atom to undergo a one-electron reaction to a capacity per unit mass of silicon.

The atomic ratio Li/Si in the negative electrode active material layer 22 in the fully discharged state may be more than or equal to 0.5. In other words, the negative electrode active material layer 22 may be formed such that the atomic ratio Li/Si is more than or equal to 0.5. With this structure, sufficient electron conductivity can be ensured during a discharging process. In this case, good discharge rate characteristics can be achieved more reliably. No particular limitation is imposed on the upper limit of the atomic ratio Li/Si in the negative electrode active material layer 22 in the fully discharged state. The upper limit is, for example, 2.0.

From the viewpoint of the energy density, the content of silicon in the silicon particles may be more than or equal to 80% by mass and may be more than or equal to 95% by mass. In this case, the initial discharge capacity of the battery 100 can be improved. The content of silicon can be measured, for example, by inductively coupled plasma emission spectrometry.

The negative electrode active material layer 22 may further contain, in addition to the negative electrode active material, unavoidable impurities, a starting material used to form the negative electrode active material layer 22, byproducts, and decomposition products. The negative electrode active material layer 22 may contain, for example, oxygen, carbon, and foreign metals.

The negative electrode active material layer 22 may contain substantially only the negative electrode active material. Specifically, the negative electrode active material layer 22 may contain substantially only silicon and lithium. In the present disclosure, the phrase “contain substantially only ***” is intended mean that a trace amount of unavoidable impurities is allowed to be mixed. The negative electrode active material layer 22 may typically be silicon and lithium themselves.

The negative electrode active material layer 22 has, for example, a structure in which a plurality of silicon particles are disposed along the surface of the negative electrode current collector 21 so as to cover the surface. In other words, the negative electrode active material layer 22 is formed as a collection of the plurality of silicon particles covering the surface of the negative electrode current collector 21. In this case, the solid electrolyte layer 30 is unlikely to come into contact with the negative electrode current collector 21, and the battery 100 having high energy density can be obtained more reliably.

In the negative electrode active material layer 22, the silicon may form, for example, a continuous phase. In this case, lithium ion conduction paths are formed in the silicon continuous phase, and therefore lithium ions can easily migrate inside the negative electrode active material layer 22.

In the negative electrode active material layer 22, part of the silicon may form, for example, a discontinuous phase. In the negative electrode active material layer 22, the silicon may be present substantially as a single element.

The negative electrode active material layer 22 may contain amorphous silicon. In the present disclosure, the term “amorphous” is not limited to a material having no crystalline structure at all but is intended to include materials having crystalline regions in a short range order. The amorphous material means, for example, a material that does not show a sharp peak derived from a crystalline structure in X-ray diffraction (XRD) but shows a broad peak derived from the amorphous structure. In the present disclosure, the phrase “contains amorphous silicon” means that at least part of the negative electrode active material layer 22 contains amorphous silicon. From the viewpoint of lithium ion conductivity, all the silicon contained in the negative electrode active material layer 22 may be amorphous.

The negative electrode active material layer 22 may contain no crystalline silicon. The silicon contained in the negative electrode active material layer 22 may be composed substantially of amorphous silicon or may contain only amorphous silicon. For example, when the negative electrode active material layer 22 is a thin film, XRD measurement is performed at a plurality of arbitrarily selected positions (for example, 5 points) of the thin film. When no sharp peak is observed at all the measurement points, it can be judged that all the silicon contained in the negative electrode active material layer 22 is amorphous silicon or is composed substantially of amorphous silicon or that the negative electrode active material layer 22 contains only amorphous silicon.

In the battery 100, the negative electrode active material layer 22 may contain an electrolyte as a result of charging or discharging. Specifically, during charging or discharging, part of the electrolyte contained in the solid electrolyte layer 30 may move from the solid electrolyte layer 30 to the negative electrode active material layer 22. However, immediately after the assembly of the battery 100 or before the initial charging and discharging, the negative electrode active material layer 22 may contain no electrolyte. With this structure, the content of silicon serving the negative electrode active material in the negative electrode active material layer 22 can be increased, so that the battery 100 obtained can have high energy density. Moreover, when the negative electrode active material layer 22 contains substantially no solid electrolyte, e.g., no sulfide solid electrolyte, the degree of contact between the metal in the negative electrode current collector 21 and the sulfide solid electrolyte can be small. Therefore, the generation of sulfides during charging or discharging of the battery 100 can be reduced. In this case, the charge-discharge rate characteristics and cycle characteristics of the battery 100 provided can be maintained for a long time. In the present disclosure, the phrase “contains no electrolyte” is intended to mean that a trace amount of the electrolyte is allowed to be mixed. The amount of the electrolyte mixed with respect to the total mass of the negative electrode active material layer 22 is less than or equal to 5% by mass, but this depends, for example, on the number of charge-discharge cycles. In the present disclosure, the term “electrolyte” is intended to include solid electrolytes and nonaqueous electrolytes.

The thickness of the negative electrode active material layer 22 is, for example, more than or equal to 1 μm. The upper limit of the thickness of the negative electrode active material layer 22 may be 40 μm and may be 20 μm. In this case, the initial discharge capacity of the battery 100 obtained is unlikely to decrease.

The thickness of the negative electrode active material layer 22 can be measured, for example, by the following method. A cross section of the negative electrode active material layer 22 is observed under a scanning electron microscope (SEM). The cross section is parallel to the laminating direction of the layers and includes the center of mass of the negative electrode active material layer 22 in plan view. Five points are arbitrarily selected from the obtained cross-sectional SEM image. The thickness of the negative electrode active material layer 22 is measured at each of the five arbitrarily selected points. The average of the measurements is regarded as the thickness of the negative electrode active material layer 22.

The material of the negative electrode current collector 21 is typically a metal. Examples of the material of the negative electrode current collector 21 include copper, nickel, stainless steel, and alloys containing any of these metals as a main component. The negative electrode current collector 21 may contain at least one selected from the group consisting of copper and nickel or may contain copper. The negative electrode current collector 21 may contain copper or nickel as a main component or may contain copper as a main component. With this structure, the battery 100 having high energy density can be obtained more reliably. In the present disclosure, the term “main component” means a component with the largest mass ratio.

From the viewpoint of electron conductivity and cost, the negative electrode current collector 21 may be formed of copper or a copper alloy. Copper reacts with, for example, a sulfide solid electrolyte to form copper sulfide. Generally, copper sulfide is a material that may serve as resistance to ionic conduction. When the negative electrode active material layer 22 of the battery 100 contains substantially no electrolyte such as solid electrolyte, i.e., when substantially no electrolyte is present on the surface of the negative electrode current collector 21, the reaction of a metal contained in the negative electrode current collector 21 and the electrolyte in the battery 100 is unlikely to occur. Therefore, even when the battery 100 including the negative electrode current collector 21 formed of copper or a copper alloy is charged and discharged, copper sulfide, for example, is unlikely to be generated. When the negative electrode active material layer 22 contains substantially no electrolyte as described above, the negative electrode current collector 21 used may contain copper.

The negative electrode current collector 21 used may be a metal foil. Examples of the metal foil include a copper foil. The copper foil may be an electrolytic copper foil. The electrolytic copper foil can be produced, for example, by the following method. First, a metal-made drum is immersed in an electrolyte solution containing copper ions dissolved therein. A current is applied while the metal-made drum is rotated. Copper thereby precipitates on the surface of the drum. The electrolytic copper foil is obtained by peeling off the precipitated copper. One or both sides of the electrolytic copper foil may be subjected to roughening treatment or surface treatment.

The surface of the negative electrode current collector 21 may or may not be roughened. With the negative electrode current collector 21 having a roughened surface, the adhesion between the negative electrode active material layer 22 and the negative electrode current collector 21 tends to be improved. Examples of the method for roughening the surface of the negative electrode current collector 21 include a method in which an electrolytic method is used to cause a metal to precipitate on the surface to thereby obtain a roughened metal surface.

The arithmetic mean roughness Ra of the surface of the negative electrode current collector 21 is, for example, greater than or equal to 0.001 μm. The arithmetic mean roughness Ra of the surface of the negative electrode current collector 21 may be greater than or equal to 0.01 μm and less than or equal to 1 μm or may be greater than or equal to 0.1 μm and less than or equal to 0.5 μm. By appropriately adjusting the arithmetic mean roughness Ra of the surface of the negative electrode current collector 21, the area of contact between the negative electrode current collector 21 and the negative electrode active material layer 22 can be increased. In this manner, the negative electrode active material layer 22 is prevented from being separated from the negative electrode current collector 21. Therefore, the battery 100 can more reliably have good charge-discharge rate characteristics. The arithmetic mean roughness Ra is a value defined in the Japanese Industrial Standards (JIS) B0601: 2013 and can be measured, for example, using a laser microscope.

No particular limitation is imposed on the thickness of the negative electrode current collector 21. The thickness of the negative electrode current collector 21 may be, for example, greater than or equal to 5 μm and less than or equal to 50 μm or may be greater than or equal to 8 μm and less than or equal to 25 μm.

The solid electrolyte layer 30 contains a solid electrolyte having lithium ion conductivity. Examples of the solid electrolyte used for the solid electrolyte layer 30 include sulfide solid electrolytes, oxide solid electrolytes, halide solid electrolytes, complex hydride solid electrolytes, and polymeric solid electrolytes. With this structure, the battery 100 obtained can have both a high capacity and good discharge rate characteristics.

The sulfide solid electrolyte used may be Li₂S—P₂S₅, Li₂S—SiS₂, Li₂S—B₂S₃, Li₂S—GeS₂, Li_{3.25}Ge_{0.25}P_{0.75}S₄, or Li₁₀GeP₂S₁₂. LiX, Li₂O, MO_{q}, LiₚMO_{q}, etc. may be added to the sulfide solid electrolyte. The element X in “LiX” is at least one selected from the group consisting of F, Cl, Br, and I. The element M in “MO_{q}” and “LiₚMO_{q}” is at least one selected from the group consisting of P, Si, Ge, B, Al, Ga, In, Fe, and Zn. p and q in “MO_{q}” and “LiₚMO_{q}” are each independently a natural number.

Examples of the oxide solid electrolyte used include: NASICON solid electrolytes typified by LiTi₂(PO₄)₃ and element-substituted products thereof; (LaLi)TiO₃-based perovskite solid electrolytes; LISICON solid electrolytes typified by Li₁₄ZnGe₄O₁₆, Li₄SiO₄, and LiGeO₄ and element-substituted products thereof; garnet solid electrolytes typified by Li₂La₃Zr₂O₁₂ and element-substituted products thereof; Li₃N and H-substituted products thereof; Li₃PO₄ and N-substituted products thereof; glass containing a base material containing a Li—B—O compound such as LiBO₂ or Li₃BO₃ with a material such as Li₂SO₄ or Li₂CO₃ added thereto; and glass ceramics.

The halide solid electrolyte is represented, for example, by compositional formula (1) below. In compositional formula (1), α, β, and γ are each independently a number larger than 0. M includes at least one selected from the group consisting of metal elements other than Li and semimetals. X includes at least one selected from the group consisting of F, Cl, Br, and I.

Li_{α}M_{β}X_{γ} formula (1)

The semimetal elements include B, Si, Ge, As, Sb, and Te. The metal elements include all elements included in groups 1 to 12 in the periodic table other than hydrogen and all elements included in groups 13 to 16 other than B, Si, Ge, As, Sb, Te, C, N, P, O, S, and Se. The metal elements are a group of elements, each of which can serve as a cation when it forms, together with a halogen compound, an inorganic compound.

The halide solid electrolyte used is Li₃YX₆, Li₂MgX₄, Li₂FeX₄, Li(Al,Ga,In)X₄, Li₃(Al,Ga,In) X₆, etc. The halide solid electrolyte exhibits good ionic conductivity.

Examples of the complex hydride solid electrolyte that can be used include LiBH₄—Lil and LiBH₄—P₂S₅.

The polymeric solid electrolyte used may be, for example, a compound prepared using a polymeric compound and a lithium salt. The polymeric compound may have an ethylene oxide structure. When the polymeric compound has the ethylene oxide structure, the polymeric compound can contain a large amount of the lithium salt, so that the ionic conductivity can be further improved. The lithium salt used may be LiPF₆, LiBF₄, LiSbF₆, LiAsF₆, LiSO₃CF₃, LIN(SO₂CF₃)₂, LIN(SO₂C₂F₅)₂, LIN(SO₂CF₃) (SO₂C₄F₉), LiC (SO₂CF₃)₃, etc. The lithium salt used may be one lithium salt selected from these lithium salts. Alternatively, the lithium salt used may be a mixture of two or more lithium salts selected from these lithium salts.

No particular limitation is imposed on the shape of the solid electrolyte contained in the solid electrolyte layer 30. For example, the solid electrolyte may have a needle shape, a spherical shape, an elliptical shape, etc. For example, the solid electrolyte may have a particle shape.

When the solid electrolyte contained in the solid electrolyte layer 30 has a particle shape (e.g., a spherical shape), the average particle diameter of the solid electrolyte particles is, for example, greater than or equal to 0.1 μm and less than or equal to 50 μm.

The average particle diameter of the solid electrolyte particles can be computed, for example, by the following method. A cross section of the solid electrolyte layer 30 is observed under a scanning electron microscope (SEM) or a transmission electron microscope (TEM), and the area of a specific solid electrolyte particle in the SEM or TEM image is computed using image analysis. The diameter of a circle having the same area as the computed area is regarded as the diameter of the specific solid electrolyte particle. The diameters of a given number (e.g., 10) of solid electrolyte particles are computed, and the average value is used as the average particle diameter of the solid electrolyte.

The positive electrode 10 includes a positive electrode current collector 11 and a positive electrode active material layer 12. The positive electrode active material layer 12 is located between the positive electrode current collector 11 and the solid electrolyte layer 30.

The material of the positive electrode current collector 11 is not limited to a specific material, and any material commonly used for batteries can be used. Examples of the material of the positive electrode current collector 11 include copper, copper alloys, aluminum, aluminum alloys, stainless steel, nickel, titanium, carbon, lithium, indium, and electrically conductive resins. The shape of the positive electrode current collector 11 is not limited to a specific shape. Examples of the shape include a foil shape, a film shape, and a sheet shape. Protrusions and recesses may be formed on the surface of the positive electrode current collector 11.

The positive electrode active material layer 12 contains a metal oxide containing lithium as a positive electrode active material. The positive electrode active material has the ability to store and release metal ions such as lithium ions. Examples of the positive electrode active material include lithium-containing transition metal oxides, transition metal fluorides, polyanion materials, fluorinated polyanion materials, transition metal sulfides, transition metal oxysulfides, and transition metal oxynitrides.

Examples of the lithium-containing transition metal oxides include Li(Ni,Co,Al) O₂, Li(Ni,Co,Mn) O₂, and LiCoO₂. In particular, when the positive electrode active material used is, for example, a lithium-containing transition metal oxide, the production cost of the positive electrode can be reduced, and the average discharge voltage can be increased. To increase the energy density of the battery 100, the positive electrode active material may contain lithium nickel cobalt manganese oxide. The positive electrode active material may be, for example, Li(Ni,Co,Mn) O₂.

The positive electrode active material layer 12 may further optionally contain at least one selected from the group consisting of a solid electrolyte, a conductive assistant, and a binder. The positive electrode active material layer 12 may contain a material mixture of positive electrode active material particles and solid electrolyte particles.

No particular limitation is imposed on the shape of the positive electrode active material. The shape of the positive electrode active material may be a needle shape, a spherical shape, or an ellipsoidal shape. For example, the positive electrode active material has a particle shape.

When the positive electrode active material has a particle shape (e.g., a spherical shape), the average particle diameter of the positive electrode active material particles is, for example, greater than or equal to 100 nm and less than or equal to 50 μm. The average particle diameter of the positive electrode active material particles can be computed by the method described above for the solid electrolyte.

The average charge-discharge potential of the positive electrode active material may be greater than or equal to 3.7 V vs Li/Li⁺ with respect to the oxidation-reduction potential of metallic lithium. The average charge-discharge potential of the positive electrode active material can be determined, for example, from the average potential when lithium is intercalated into and deintercalated from the positive electrode active material with metallic lithium used as a counter electrode. When a material other than metallic lithium is used as the counter electrode, the average potential may be determined by adding the potential of the material used for the counter electrode with respect to the metallic lithium to the charge-discharge curve. When a material other than metallic lithium is used as the counter electrode, the battery may be charged and discharged using a relatively low current value in consideration of ohmic loss.

At least one selected from the group consisting of the positive electrode 10, the solid electrolyte layer 30, and the negative electrode 20 may contain a binder for the purpose of improving the adhesion between particles. The binder is used to improve, for example, the binding properties of the material forming the electrodes. Examples of the binder include polyvinylidene fluoride, polytetrafluoroethylene, polyethylene, polypropylene, aramid resins, polyamides, polyimides, polyamide-imides, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyethers, polyethersulfone, hexafluoropolypropylene, styrene-butadiene rubber, and carboxymethyl cellulose. The binder used may be a copolymer of at least two materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. The binder used may be a mixture of at least two materials selected from the above-described materials.

At least one selected from the group consisting of the positive electrode 10 and the negative electrode 20 may contain a conductive assistant for the purpose of improving electron conductivity. Examples of the conductive assistant include graphite, carbon black, conductive fibers, fluorinated carbon, metal powders, conductive whiskers, conductive metal oxides, and conductive polymers. Examples of the graphite include natural graphite and artificial graphite. Examples of the carbon black include acetylene black and Ketjen black. Examples of the conductive fibers include carbon fibers and metal fibers. Examples of the metal powder include aluminum. Examples of the conductive whisker include zinc oxide and potassium titanate. Examples of the conductive metal oxide include titanium oxide. Examples of the conductive polymer compound include polyaniline, polypyrrole, and polythiophene. When a conductive assistant containing carbon is used, a reduction in cost can be achieved.

No particular limitation is imposed on the operating temperature of the battery 100 in the present embodiment. The operating temperature is, for example, higher than or equal to −50° C. and lower than or equal to 100° C. The higher the operating temperature of the battery 100, the further the ionic conductivity can be improved, so that the battery 100 can be operated at higher power.

The area of the principal surface of the battery 100 is larger than or equal to 1 cm² and less than or equal to 100 cm². In this case, the battery 100 can be used for portable electronic devices such as smartphones and digital cameras. Alternatively, the area of the principal surface of the battery 100 may be larger than or equal to 100 cm² and less than or equal to 1000 cm². In this case, the battery 100 can be used for power sources of large-size mobile apparatuses such as electric vehicles. The “principal surface” means a surface of the battery 100 that has the largest area.

The battery 100 in the present embodiment may be formed as batteries with different shapes such as coin-shaped, cylindrical, square, sheet-shaped, button-shaped, flattened, and laminated batteries.

### Method for Producing Battery

The battery 100 in the present embodiment can be produced, for example, by the following method.

The negative electrode current collector 21 used is, for example, an electrolytic copper foil having a surface roughened by precipitating copper by an electrolytic method.

Next, a silicon thin film is formed on the negative electrode current collector 21. The negative electrode 20 is thereby produced.

No particular limitation is imposed on the method for forming the silicon thin film on the negative electrode current collector 21. For example, a chemical vapor deposition (CVD) method, a sputtering method, a vapor deposition method, a thermal spraying method, or a plating method may be used. The silicon thin film can also be formed on the negative electrode current collector 21 by a coating method including applying a paste containing a solution containing silicon particles and a binder.

No particular limitation is imposed on the method for pre-storing lithium in silicon in the negative electrode active material layer 22. Any of the methods described above may be used to pre-store lithium in silicon in the negative electrode active material layer 22.

Next, a powder of the solid electrolyte is placed in an electrically insulating cylinder. The solid electrolyte powder is pressed to form the solid electrolyte layer 30. Next, the negative electrode 20 produced is placed in the cylinder. Pressure is applied to the inside of the cylinder. A laminated body including the negative electrode 20 and the solid electrolyte layer 30 is thereby produced.

After the formation of the laminated body, a powder of the positive electrode active material and the positive electrode current collector are placed in the cylinder containing the laminated body, and pressure is applied to the cylinder. A laminated body including the negative electrode 20, the solid electrolyte layer 30, and the positive electrode 10 is thereby produced. Finally, an electrically insulating ferrule is used to seal and isolate the inside of the electrically insulating cylinder from the external environment. The battery 100 in the present embodiment is thereby produced.

The battery 100 may be charged and discharged with pressure applied to the battery 100. The direction of the pressure application is, for example, the same as the laminating direction of the members of the battery 100. No particular limitation is imposed on the pressure applied to the battery 100. The pressure is, for example, higher than or equal to 0.3 MPa and lower than or equal to 300 MPa.

### Examples

The details of the present disclosure will be described by way of Examples. However, the battery of the disclosure is not limited to the following Examples.

### Production of Negative Electrode

An electrolytic method was used to precipitate copper on an electrolytic copper foil to roughen the surface thereof, and the resulting electrolytic copper foil was used as a negative electrode current collector. The thickness of the roughened electrolytic copper foil was 45 μm. Next, an RF sputtering device was used to form a silicon thin film on the negative electrode current collector. Argon gas was used for the sputtering. The pressure of the argon gas was 0.24 Pa. A negative electrode including the negative electrode current collector and the silicon thin film was thereby obtained. By adjusting the deposition time, three negative electrode samples (negative electrodes 1 to 3) with different silicon deposition amounts were produced. For each of the negative electrodes 1 to 3, the mass of silicon B_{N} (mg/cm²) contained in a unit area of the silicon thin film was determined. The results are shown in Table 1. The mass of silicon B_{N} (mg/cm²) contained in a unit area of the silicon thin film was determined by inductively coupled plasma emission spectrometry. The thickness of the silicon thin film was determined by dividing the mass B_{N} of silicon by the true density of silicon (2.33 g/cm³). The true density of silicon was measured by a pycnometer method.

### Production of Solid Electrolyte

Li₂S raw material powder and P₂S₅ raw material powder were weighed in an argon glove box with a dew point lower than or equal to −60° C. such that their molar ratio was Li₂S:P₂S₅=75:25. The raw material powders were pulverized in a mortar and mixed to obtain a mixture. Then a planetary ball mill (type P-7 manufactured by Fritsch) was used to subject the mixture to milling treatment under the conditions of 510 rpm for 10 hours. A glass-like solid electrolyte was thereby obtained. The solid electrolyte obtained was subjected to heat treatment in an inert atmosphere under the conditions of 270° C. for 2 hours. Glass ceramic-like Li₂S—P₂S₅ serving as a sulfide solid electrolyte was thereby obtained.

### Production of Positive Electrode Mixture

LiNi_{0.8}Co_{0.01}Mn_{0.1}O₂ (hereinafter referred to as NCM) was used as a positive electrode active material. The NCM and Li₂S—P₂S₅ were mixed in a mortar such that their mass ratio was 85:15 to thereby obtain a positive electrode mixture.

### Production of Battery for Evaluation of Negative Electrode Capacity

80 mg of Li₂S—P₂S₅ was added to an electrically insulating cylinder having an inner diameter of 9.4 mm. Next, the negative electrode 1 punched to a diameter of 9.4 mm was added, and pressure forming was performed at 370 MPa. A laminated body including the negative electrode and the solid electrolyte layer was thereby produced.

Next, a metallic indium foil having a thickness of 200 μm, a metallic lithium foil having a thickness of 300 μm, and a metallic indium foil having a thickness of 200 μm were disposed in this other on the solid electrolyte layer of the laminated body. A three-laminated body including the negative electrode, the solid electrolyte layer, and the indium-lithium-indium layer was thereby produced. Next, the three-laminated body was subjected to pressure forming at 80 MPa. A two-electrode type electrochemical cell including the negative electrode serving as a working electrode and the indium-lithium-indium layer serving as a counter electrode was thereby produced. Next, current collectors containing stainless steel were disposed on the upper and lower sides of the electrochemical cell, and current collector leads were attached to the current collectors. An electrically insulating ferrule was used to seal and isolate the inside of the electrically insulating cylinder from the external environment. Four bolts were used to hold the electrochemical cell from the upper and lower sides to apply a pressure of 150 MPa. The thus-obtained half-cell is referred to as a battery for evaluation of negative electrode capacity.

### Charge-Discharge Test on Battery for Evaluation of Negative Electrode Capacity

A charge-discharge test was performed on the battery for evaluation of negative electrode capacity under the following conditions.

The battery for evaluation of negative electrode capacity was placed in a thermostatic oven at 25° C.

The theoretical capacity of silicon serving as the negative electrode active material is 4200 mAh/g. The battery for evaluation of negative electrode capacity was charged at a constant current corresponding to 20 hour rate, i.e., 0.05C rate, for a capacity of 3000 mAh/g corresponding to about 70% of the theoretical value. When the potential of the working electrode with respect to the counter electrode reached-0.62 V, the charging was terminated. Next, the battery was discharged at a current value corresponding to 0.05C, and the discharge was terminated at a voltage of 1.4 V. A value AN obtained by converting the initial charge capacity to the charge capacity per unit mass of silicon was 3500 mAh/g. The product of the value AN and the mass B_{N} (mg/cm²) of silicon contained in a unit area of the silicon thin film was used to determine the charge capacity N (mAh/cm²) per unit area of the negative electrode. The results are shown in Table 1.

For each of the negative electrodes 2 and 3, a battery for evaluation of negative electrode capacity was produced using the same method as for the negative electrode 1. The charge-discharge test was performed on each of the batteries for evaluation of negative electrode capacity using the same method as for the negative electrode 1 to determine the charge capacity N (mAh/cm²) per unit area of the negative electrode. The results are shown in Table 1.

The test conditions for the charge-discharge test performed on each battery for evaluation of negative electrode capacity are the same as the test conditions for a charge-discharge test in which the battery is charged to 0 V with respect to the potential of metallic lithium and then discharged to 2.02 V.

TABLE 1

| | Negative | Negative | electrode 3 |
|---|---|---|---|
| Negative electrode sample No. | electrode 1 | electrode 2 | Negative |
| Mass B_{N} of silicon contained in | 0.723 | 1.207 | 1.818 |
| unit area of silicon thin film | | | |
| (mg/cm²) | | | |
| Thickness of silicon thin film | 3.1 | 5.1 | 7.8 |
| (μm) | | | |
| Charge capacity N per unit area | 2.53 | 4.23 | 6.36 |
| of negative electrode (mAh/cm²) | | | |

Production of Negative Electrode Containing Silicon with Lithium Stored Therein

A half-cell was produced by the following method, and a negative electrode containing silicon with lithium electrochemically pre-stored therein was thereby produced.

80 mg of Li₂S—P₂S₅ was added to an electrically insulating cylinder having an inner diameter of 9.4 mm. Next, the negative electrode 1 punched to a diameter of 9.4 mm was placed, and pressure forming was performed at 370 MPa. A laminated body including the negative electrode and the solid electrolyte layer was thereby produced.

Next, a metallic indium foil having a thickness of 200 μm, a metallic lithium foil having a thickness of 300 μm, and a metallic indium foil having a thickness of 200 μm were disposed in this other on the solid electrolyte layer of the laminated body. A three-laminated body including the negative electrode, the solid electrolyte layer, and the indium-lithium-indium layer was thereby produced. Next, the three-laminated body was subjected to pressure forming at 80 MPa. A two-electrode type electrochemical cell including the negative electrode serving as a working electrode and the indium-lithium-indium layer serving as a counter electrode was thereby produced. Next, current collectors containing stainless steel were disposed on the upper and lower sides of the electrochemical cell, and current collector leads were attached to the current collectors. An electrically insulating ferrule was used to seal and isolate the inside of the electrically insulating cylinder from the external environment. Four bolts were used to hold the electrochemical cell from the upper and lower sides to apply a pressure of 12 MPa to the laminated body. The thus-obtained half-cell is referred to as a half-cell 1.

### Energization Test

Next, an energization test was performed on the half-cell 1 under the following conditions. The energization test was performed with the half-cell 1 placed in a thermostatic oven at 25° C.

The theoretical capacity of silicon serving as the negative electrode active material is 4200 mAh/g. The half-cell 1 was energized at a constant current corresponding to 20 hour rate (0.05C rate) for a capacity of 3000 mAh/g corresponding to about 70% of the theoretical value to allow lithium to be electrochemically stored in silicon contained in the negative electrode of the half-cell 1. A half-cell 1-1 was thereby obtained. The negative electrode removed from the half-cell 1-1 is referred to as a negative electrode 1-1.

The atomic ratio Li/Si in the negative electrode 1-1 after the energization was determined by dividing the capacity X (mAh/g) when a unit mass of silicon was energized by 954 mAh/g. The 954 mAh/g is a value obtained by converting the capacity necessary to allow a silicon atom to undergo a one-electron reaction to a capacity per unit mass of silicon. The results are shown in Table 2.

A half-cell 2 was produced using the same method as for the half-cell 1 except that the negative electrode 2 was used instead of the negative electrode 1. The energization test was performed on the half-cell 2 under the same conditions as for the half-cell 1 to thereby obtain a half-cell 2-1 and a half-cell 2-2. The negative electrodes removed from the half-cell 2-1 and the half-cell 2-2 are referred to as a negative electrode 2-1 and a negative electrode 2-2, respectively. The atomic ratio Li/Si in each of the negative electrodes 2-1 and 2-2 was determined by the same method as for the negative electrode 1-1. The results are shown in Table 2.

A half-cell 3 was produced using the same method as for the half-cell 1 except that the negative electrode 3 was used instead of the negative electrode 1. The energization test was performed on the half-cell 3 under the same conditions as for the half-cell 1 to thereby obtain a half-cell 3-1, a half-cell 3-2, and a half-cell 3-3. The negative electrodes removed from the half-cell 3-1, the half-cell 3-2, and the half-cell 3-3 are referred to as a negative electrode 3-1, a negative electrode 3-2, and a negative electrode 3-3, respectively. The atomic ratio Li/Si in each of the negative electrodes 3-1, 3-2, and 3-3 was determined by the same method as for the negative electrode 1-1. The results are shown in Table 2.

TABLE 2

| Negative electrode sample No. | Atomic ratio Li/Si |
|---|---|
| Negative electrode 1 | 0 |
| Negative electrode 1-1 | 0.24 |
| Negative electrode 2 | 0 |
| Negative electrode 2-1 | 0.54 |
| Negative electrode 2-2 | 1.03 |
| Negative electrode 3 | 0 |
| Negative electrode 3-1 | 0.71 |
| Negative electrode 3-2 | 1.3 |
| Negative electrode 3-3 | 1.88 |

### Production of Battery for Evaluation of Positive Electrode Capacity

80 mg of Li₂S—P₂S₅ was added to an electrically insulating cylinder having an inner diameter of 9.4 mm, and pressure forming was performed at 50 MPa. A solid electrolyte layer was thereby produced. Next, 12.0 mg of the positive electrode mixture was placed on one side of the solid electrolyte layer, and pressure forming was performed at 370 MPa. A laminated body including the positive electrode and the solid electrolyte layer was thereby produced.

Next, a metallic indium foil having a thickness of 200 μm, a metallic lithium foil having a thickness of 300 μm, and a metallic indium foil having a thickness of 200 μm were disposed in this other on the solid electrolyte layer of the laminated body. A three-laminated body including the positive electrode, the solid electrolyte layer, and the indium-lithium-indium layer was thereby produced. Next, the three-laminated body was subjected to pressure forming at 80 MPa. A two-electrode type electrochemical cell including the positive electrode serving as a working electrode and the indium-lithium-indium layer serving as a counter electrode was thereby produced. Next, current collectors containing stainless steel were disposed on the upper and lower sides of the electrochemical cell, and current collector leads were attached to the current collectors. An electrically insulating ferrule was used to seal and isolate the inside of the electrically insulating cylinder from the external environment. Four bolts were used to hold the electrochemical cell from the upper and lower sides to apply a pressure of 150 MPa. The thus-obtained half-cell is referred to as a battery for evaluation of positive electrode capacity.

### Charge-Discharge Test on Battery for Evaluation of Positive Electrode Capacity

The charge-discharge test was performed on the battery for evaluation of positive electrode capacity under the following conditions.

The battery for evaluation of positive electrode capacity was placed in a thermostatic oven at 25° C.

The battery for evaluation of positive electrode capacity was charged at a constant current of 0.073 mA. When the potential of the working electrode with respect to the counter electrode reached 3.7 V, the charging was terminated. Next, the battery was discharged at a current value of 0.073 mA, and the discharge was terminated at a voltage of 1.85 V. A value A_{P} obtained by converting the initial charge capacity to the charge capacity per unit mass of NCM was 210 mAh/g. A value obtained by converting the initial charge capacity to the charge capacity per unit area of the positive electrode was 2.14 mAh/cm².

### Production of Battery

80 mg of Li₂S—P₂S₅ was added to an electrically insulating cylinder having an inner diameter of 9.4 mm, and pressure forming was performed at 50 MPa. A solid electrolyte layer was thereby produced. Next, 12.1 mg of the positive electrode mixture was placed on one side of the solid electrolyte layer, and the negative electrode 1 punched to a diameter of 9.4 mm was placed on the other side of the solid electrolyte layer. The resulting product was subjected to pressure forming at 370 MPa. A laminated body including the positive electrode, the solid electrolyte layer, and the negative electrode was thereby produced. Next, current collectors containing stainless steel were placed on the positive and negative electrodes, and then current collector leads were attached to the current collectors. An electrically insulating ferrule was used to seal and isolate the inside of the electrically insulating cylinder from the external environment. Four bolts were used to hold the laminated body from the upper and lower sides to apply a pressure of 1 MPa. A battery 1 including the negative electrode 1 was thereby obtained.

A battery 1-1 including the negative electrode 1-1, a battery 2 including the negative electrode 2, a battery 2-1 including the negative electrode 2-1, a battery 2-2 including the negative electrode 2-2, a battery 3 including the negative electrode 3, a battery 3-1 including the negative electrode 3-1, a battery 3-2 including the negative electrode 3-2, and a battery 3-3 including the negative electrode 3-3 were produced using the same method as for the battery 1 except that the positive electrode mixture was added such that the mass of the positive electrode per unit area was a value shown in Table 3.

The ratio N/P of each of the batteries 1 to 3-3 was determined by the method described above. Specifically, the ratio N/P was determined by dividing the charge capacity N (mAh/cm²) per unit area of the negative electrode by the charge capacity P (mAh/cm²) per unit area of the positive electrode. More specifically, the ratio N/P was determined by dividing the product of B_{N} (mg/cm²) and A_{N}(mAh/g) by the product of Bp (mg/cm²) and A_{P}(mAh/g). B_{N}(mg/cm²) is the mass of silicon contained in a unit area of the silicon thin film. A_{N}(mAh/g) is a value determined previously and obtained by converting the initial charge capacity to the charge capacity per unit mass of silicon and is 3500 mAh/g. B_{P}(mg/cm²) is the mass of NCM contained in a unit area of the positive electrode. A_{P}(mAh/g) is a value determined previously and obtained by converting the initial charge capacity to the charge capacity per unit mass of NCM and is 210 mAh/g. The results are shown in Table 3.

### Charge-Discharge Test

A charge-discharge test was performed on the battery 1 under the following conditions. The charge-discharge test was performed with the battery 1 placed in a thermostatic oven at 25° C.

### Evaluation of Initial Discharge Capacity

The battery 1 was charged at a constant current value corresponding to 20 hour rate (0.05C rate) to a voltage of 4.2 V. Next, the battery 1 was discharged at a current value corresponding to 0.05C rate to 2.0 V. This procedure was repeated twice.

A discharge capacity (mAh/cm²) obtained by converting the discharge capacity at the second cycle to a discharge capacity per unit area of the positive and negative electrodes was used as the initial discharge capacity. The results are shown in Table 3.

The initial discharge capacity of each of the batteries 1-1 to 3-3 was evaluated using the same method as for the battery 1. The results are shown in Table 3.

The atomic ratio Li/Si in each of the negative electrodes 1 to 3-3 after the charging was determined by the method described above. Specifically, the following method was used to determine the atomic ratio Li/Si. The results are shown in Table 3.

A charge capacity Y (mAh/g) was divided by 954 mAh/g to compute the atomic ratio Li/Si after the charging. The charge capacity Y (mAh/g) is a value obtained by converting the charge capacity at the first cycle to a value per unit mass of silicon. The above 954 mAh/g is a value obtained by converting the capacity necessary to allow a silicon atom to undergo a one-electron reaction to a capacity per unit mass of silicon. As for each battery using the negative electrode containing silicon with lithium pre-stored therein, the atomic ratio Li/Si was computed by dividing the sum of the capacity X (mAh/g) and the charge capacity Y (mAh/g) by 954 mAh/g. The capacity X (mAh/g) is the capacity when a unit mass of silicon was energized before the assembly of the battery.

### Evaluation of Discharge Rate Characteristics

The discharge rate characteristics of the battery I used for the evaluation of the initial discharge capacity were evaluated. After the evaluation of the initial discharge capacity, the battery 1 was charged at a constant current value corresponding to a charging rate of 0.05C to 4.2 V and then discharged at a current value corresponding to 1C rate to 2.0 V, and the discharge capacity at 1C rate was thereby obtained. After a rest of 20 minutes, the battery was discharged at a current value corresponding to 0.05C rate to 2.0 V to fully discharge the battery.

A value obtained by dividing the discharge capacity obtained at 1C by the discharge capacity at 0.05C determined at the second cycle was computed as a 1C discharge capacity retention rate with respect to the 0.05C discharge capacity. The results are shown in Table 3.

FIG. 2 is a 1C discharge curve of the battery 1. In FIG. 2, the vertical axis represents voltage (V), and the horizontal axis represents discharge capacity (mAh). The average discharge voltage was computed using the discharge curve in FIG. 2. The discharge capacity at the end of discharging is set to 100%, and the average discharge voltage is an average voltage value in the range in which the discharge capacity is 0% to 100%. The results are shown in Table 3.

The discharge rate characteristics of each of the batteries 1-1 to 3-3 were evaluated using the same method as for the battery 1. The results are shown in Table 3.

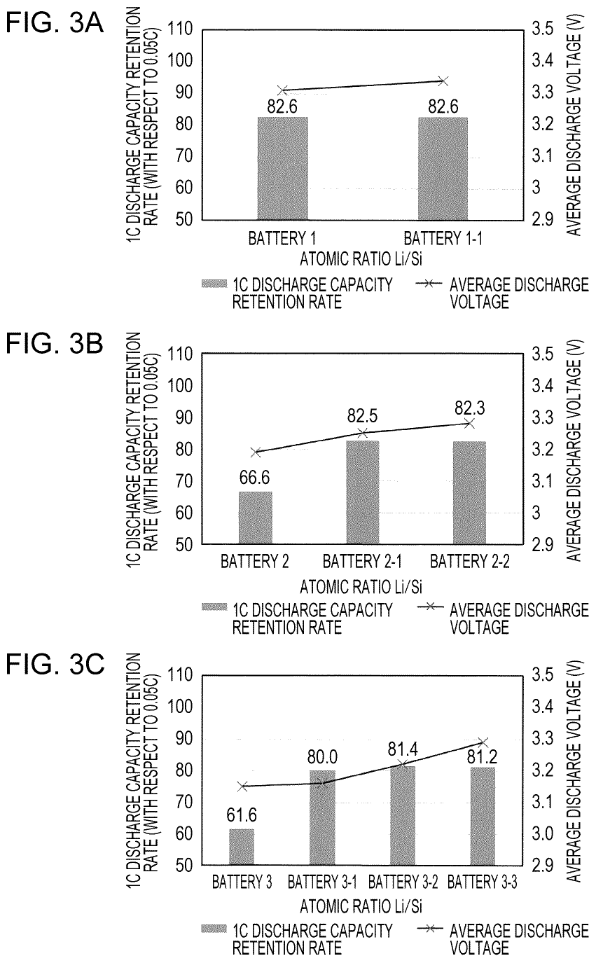

FIG. 3A is a graph showing the relation between the 1C discharge capacity retention rate and the atomic ratio Li/Si and the relation between the average discharge voltage and the atomic ratio Li/Si for each of the battery 1 including the negative electrode 1 and the battery 1-1 including the negative electrode 1-1. FIG. 3B is a graph showing the relation between the 1C discharge capacity retention rate and the atomic ratio Li/Si and the relation between the average discharge voltage and the atomic ratio Li/Si for each of the battery 2 including the negative electrode 2, the battery 2-1 including the negative electrode 2-1, and the battery 2-2 including the negative electrode 2-2. FIG. 3C is a graph showing the relation between the 1C discharge capacity retention rate and the atomic ratio Li/Si and the relation between the average discharge voltage and the atomic ratio Li/Si for each of the battery 3 including the negative electrode 3, the battery 3-1 including the negative electrode 3-1, the battery 3-2 including the negative electrode 3-2, and the battery 3-3 including the negative electrode 3-3.

TABLE 3

| | Mass of positive | | | Initial | 1 C discharge | 1 C average |
|---|---|---|---|---|---|---|
| | electrode mixture | | Atomic | discharge | capacity | discharge |
| | per unit area | Ratio | ratio | capacity | retention | voltage |
| Battery No. | (mg/cm²) | N/P | Li/Si | (mAh/cm²) | rate (%) | (V) |
| Battery 1 | 12.1 | 1.2 | 0 | 2.00 | 82.6 | 3.31 |
| Battery 1-1 | 13.1 | 1.1 | 0.24 | 2.02 | 82.6 | 3.34 |
| Battery 2 | 11.5 | 2.1 | 0 | 1.97 | 66.6 | 3.19 |
| Battery 2-1 | 11.5 | 2.1 | 0.54 | 1.99 | 82.5 | 3.25 |
| Battery 2-2 | 12.7 | 1.9 | 1.03 | 2.11 | 82.3 | 3.28 |
| Battery 3 | 13.2 | 2.7 | 0 | 1.81 | 61.6 | 3.15 |
| Battery 3-1 | 12.9 | 2.8 | 0.71 | 2.18 | 80.0 | 3.16 |
| Battery 3-2 | 13.2 | 2.7 | 1.3 | 2.17 | 81.4 | 3.22 |
| Battery 3-3 | 12.8 | 2.8 | 1.88 | 2.11 | 81.2 | 3.29 |

### DISCUSSION

In the battery 1-1, the average discharge voltage was higher than that in the battery 1, and the discharge rate characteristics were improved. In the battery 1-1, no change in the 1C discharge capacity retention rate was found. The reason for this may be as follows. In the battery 1, the initial discharge capacity is 2.00 mAh/cm², and the ratio N/P is 1.2. Moreover, as shown in Table 1, the thickness of the silicon thin film is smaller than those in the batteries 2 and 3. Therefore, the resistance of the negative electrode of the battery 1 is not so high. For the above reason, even when the silicon with lithium pre-stored therein was used as the negative electrode active material, the 1C discharge capacity retention rate did not change.

In the batteries 2-1 and 2-2, the 1C discharge capacity retention rate was more than or equal to 82% and was higher than that in the battery 2. In the batteries 2-1 and 2-2, the average discharge voltage was higher than that in the battery 2. As described above, in the batteries 2-1 and 2-2, the discharge rate characteristics were found to be improved. In the batteries 3-1, 3-2, and 3-3, the 1C discharge capacity retention rate was more than or equal to 80% and was higher than that in the battery 3. In the batteries 3-1, 3-2, and 3-3, the average discharge voltage was found to be higher than that in the battery 3. As described above, in the batteries 3-1, 3-2, and 3-3, the discharge rate characteristics were found to be improved. This may be because, since the silicon with lithium pre-stored therein was used as the negative electrode active material, the electron conductivity of the negative electrode was particularly improved. When the negative electrode is formed such that the atomic ratio Li/Si is more than or equal to 0.5, the discharge rate characteristics may be further improved.

In the battery 1-1, the ratio N/P is close to 1. Therefore, when the negative electrode containing the silicon with lithium pre-stored therein is used, the load of silicon is more than or equal to 3300 mAh/g in the fully charged state, and the atomic ratio Li/Si is more than or equal to 3.5 in the fully charged state. Since the theoretical maximum value of the atomic ratio Li/Si is 4.4, it is feared that, in the battery 1-1, lithium may precipitate in a dendritic form during rapid charging, due to cycle deterioration, etc. Therefore, the atomic ratio Li/Si in the fully charged state is desirably less than or equal to 3.5 and more desirably less than or equal to 3.

The battery of the disclosure can be used, for example, for vehicle-mounted lithium ion secondary batteries.

What is claimed is:

1. A battery comprising:
a positive electrode;
a negative electrode; and
a solid electrolyte layer located between the positive electrode and the negative electrode,
wherein the positive electrode contains, as a positive electrode active material, a metal oxide containing lithium,
wherein the negative electrode includes a negative electrode current collector and a negative electrode active material layer located between the negative electrode current collector and the solid electrolyte layer,
wherein the negative electrode active material layer contains, as a negative electrode active material, silicon with lithium pre-stored therein, and
wherein the atomic ratio of lithium to silicon in the negative electrode active material layer in a fully charged state is less than or equal to 3.5.

2. The battery according to claim 1, wherein the ratio of the charge capacity per unit area of the negative electrode to the charge capacity per unit area of the positive electrode is more than or equal to 1.9.

3. The battery according to claim 1, wherein the atomic ratio of lithium to silicon in the negative electrode active material layer in a fully discharged state is more than or equal to 0.5.

4. The battery according to claim 1, wherein the negative electrode active material layer contains no electrolyte.

5. The battery according to claim 1, wherein the solid electrolyte layer contains a solid electrolyte having lithium ion conductivity.

6. The battery according to claim 5, wherein the solid electrolyte contains a sulfide solid electrolyte.

7. A method of using a battery, the method comprising charging the battery including a positive electrode containing, as a positive electrode active material, a metal oxide containing lithium and a negative electrode including a negative electrode active material layer containing, as a negative electrode active material, silicon with lithium pre-stored therein, the battery being charged such that the atomic ratio of lithium to silicon in the negative electrode active material layer in a fully charged state is less than or equal to 3.5.
